(19) United States
(12) Patent Application Publication
(10) Pub. No.: US 2015/0122000 A1
(43) Pub. Date: May 7, 2015

(54) METHOD FOR DETECTING AN ERROR IN THE OPENING BEHAVIOR OF AN INJECTOR

(71) Applicant: Robert Bosch GmbH, Stuttgart (DE)

(72) Inventors: Markus WILLIMOWSKI, Freiberg A.N. (DE); Markus AMLER, Leonberg-Gebersheim (DE); Alexander SCHENCK ZU SCHWEINSBERG, Moeglingen (DE); Florian STIEF, Stuttgart (DE); Klaus JOOS, Walheim (DE)

(21) Appl. No.: 14/533,577

(22) Filed: Nov. 5, 2014

(30) Foreign Application Priority Data
Nov. 7, 2013 (DE) 10 2013 222 603.9

(51) Int. Cl. F02M 65/00; F02M 51/00

(52) U.S. Cl. CPC F02M 65/00; F02M 51/00
USPC 73/114.45

(57) ABSTRACT

A method for detecting an error in the opening behavior of an injector of an internal combustion engine, the injector having an electromagnetically actuated valve element, a ballistic partial injection being carried out, the injector being ballistically activated, so that the valve element is not opened up to a lift stop, a ballistic closing delay period is determined, the determined ballistic closing delay period is compared with a reference value, and an error in the opening behavior of the injector is detected with the aid of the comparison.

### RELATED APPLICATION INFORMATION

The present application claims priority to and the benefit of German patent application no. 10 2013 222 603.9, which was filed in Germany on Nov. 7, 2013, the disclosure of which is incorporated herein by reference.

### FIELD OF THE INVENTION

The present invention relates to a method for detecting an error in the opening behavior of an injector.

### BACKGROUND INFORMATION

Injectors are known and are used in various ways, in particular as fuel injectors in internal combustion engines. Magnetic and piezoelectric injectors are widely used. A typical injector includes an electrically activatable valve element which may unblock and block a flow path of the fuel. The valve element includes a valve needle (or an injector needle) and a magnetic actuator (an armature or a magnet armature and a coil) or a piezoelectric actuator. The actuator is coupled to the valve needle and is electrically activated. The actuator and the valve needle are pressed by a valve spring into a de-energized final position (“normal position,” “zero position”). In this non-actuated final position, the flow path of the fuel is either closed (NC) or opened (NO).

In the case of a magnetic injector, an electromagnetic force is generated due to an activation in the form of an electrical energization of a solenoid coil, for example in the course of a main energization or a main activation, this force moving the armature together with the valve needle against the force of the valve spring. This, in turn, results in that in the case of an NC injector, the flow of the fuel is unblocked or, in the case of an NO injector, the flow of the fuel is blocked.

When the energization of the magnetic injector ends, the magnetic field which holds the armature in the actuated position of the magnetic injector is reduced. Subsequently, the force of the valve spring which counteracts the magnetic field prevails. This force acts on the armature in such a way that the latter moves away from the solenoid coil. This, in turn, results in the valve element changing into the non-actuated final position.

In the case of a piezoelectric injector, a valve needle of a corresponding valve element is activated analogously. Here, the valve element is moved with the aid of a piezoelectric actuator instead of energizing a solenoid coil. By applying a voltage to the piezoelectric actuator, the latter is charged, thus resulting in an opening of the valve needle. If the piezoelectric actuator is discharged, the needle is re-closed.

During this process, delay periods occur in injectors. An opening delay period is the period between the beginning of the activation and an opening point in time at which the flow of the fuel or a fuel delivery is unblocked. A closing delay period is the period between the end of the activation and a closing point in time at which the unblocking of the fuel delivery ends. The time period between the opening point in time and the closing point in time is referred to as an opening duration in this case, during which a certain quantity of fuel is delivered through the injector. The time period between the beginning and the end of the activation is referred to as an activation period. In order to precisely control the injector and this delivered fuel quantity, the opening delay period and the closing delay period or the exact opening point in time and closing point in time of the injector must therefore be known.

For this purpose, the closing delay period may be determined in a simple manner even during the regular ongoing operation of the internal combustion engine. The closing point in time may be determined in the course of controlling the injector (e.g., a controlled valve operation, CVO). For this purpose, a voltage signal of a solenoid coil may be examined, for example. A movement of the armature may be inferred from this voltage signal.

In this way, the closing point in time and, ultimately, also the closing delay period may be determined from the voltage signal.

A method discussed in DE 10 2009 028 650 A1, for example, for determining the opening delay period of a magnetic injector (or fuel injector). Here, a maximum activation period and a maximum opening duration of the magnetic injector are ascertained, in the case of which fuel is not injected just yet. Furthermore, a closing period of the magnetic injector is ascertained for this maximum activation period and maximum opening duration in each case. These results are used to ascertain the opening delay period.

For diagnosis reasons, e.g., in the course of an on-board diagnosis, it may be necessary to permanently monitor whether an error is present in the opening behavior of the injector. An error of this type in the opening behavior means in most cases a change in the opening delay period due to wear and tear of the injector, for example. Errors which, for example, result in increased fuel consumption and increased emissions of the internal combustion engine should be detected early on. Determining the opening delay period according to DE 10 2009 028 650 A1, for example, is, however, very complex and requires a lot of effort, and cannot be readily implemented in the ongoing operation of an internal combustion engine.

It is therefore desirable to provide a possibility of being able to detect an error in an opening behavior of an injector in a simple manner.

### SUMMARY OF THE INVENTION

According to the present invention, a method for detecting an error in the opening behavior of an injector having the features described herein is provided. Advantageous embodiments are the subject matter of the subclaims as well as of the following description.

According to the present invention, a ballistic partial injection is carried out. In a ballistic partial injection of this type, the injector is activated ballistically so that the valve element is not opened up to a lift stop. The valve element includes a valve needle, in particular. As a result of the ballistic partial injection, the valve element is activated in such a way that the valve needle does not carry out a complete lift and is only slightly set in motion.

In contrast to the ballistic partial injection, full stroke injection refers to the injector being activated in such a way that the valve needle moves up to a lift stop and the injector is fully opened.

According to the present invention, a ballistic closing delay period is determined in the course of the ballistic partial injection. This ballistic closing delay period is, in this case, the period between the end of the energization of the injector and a closing point in time starting from which the injector is closed or at which a fuel delivery through the injector ends. An error in the opening behavior of the injector is detected or determined from a comparison of the closing delay period with a reference value.

The method according to the present invention may, in this case, be carried out during the regular operation of the internal combustion engine, since the ballistic partial injection may be advantageously carried out in a quantity and torque neutral manner. The present invention is to be carried out simply and with little effort. There is no need for carrying out retrofitting measures at the internal combustion engine. Thus, an on-board diagnosis may be implemented in which it is monitored during the regular operation of the internal combustion engine whether an error is present in the opening behavior of the injector. In this way, the individual injectors of an internal combustion engine may be monitored in a simple manner. A defective injector having an error in the opening behavior may thus be detected early and replaced. In particular, a corresponding measure may be carried out when an error in the opening behavior is detected.

For example, an acoustic or a visual warning message may be output.

Due to an error of this type in the opening behavior, an opening delay period of the injector changes, in particular. In particular, the opening delay period increases. Thus, the opening duration of the injector and the delivered fuel quantity also change. With the aid of the present invention, it may therefore be detected early when the delivered fuel quantity changes due to an error in the opening behavior.

The present invention utilizes a special property of the ballistic partial injection. Due to the fact that the valve needle does not move up to a lift stop, the movement of the valve needle for opening the injector directly transitions into the movement for closing the injector. The opening (or opening behavior) and closing (or closing behavior) of the injector are therefore coupled to one another. In a ballistic partial injection, an error in the opening behavior of the injector also influences the closing behavior of the injector. In contrast, the opening behavior and the closing behavior of the injector are decoupled from one another in the full stroke injection. In a full stroke injection, an error in the opening behavior does not affect the closing behavior and thus the closing delay period of the injector.

The injector may be, in particular, configured as a magnetic injector or as a piezoelectric injector. In this case, the valve element of a magnetic injector has, in particular, an armature or a magnet armature. In the course of the ballistic partial injection, a coil of the magnetic injector is activated for a comparably short period of time. Before the armature reaches a lift stop and before the magnetic injector is fully opened, the armature and the valve needle move in the opposite direction and the magnetic injector re-closes. The valve element of a piezoelectric injector has, in particular, a piezoelectric actuator. In this case, this piezoelectric actuator is activated for a comparably short period of time in the course of the ballistic partial injection.

The ballistic partial injection advantageously precedes or succeeds the full stroke injection. The internal combustion engine or the injector is, in this case, operated during the regular ongoing operation in the full stroke injection. The ballistic partial injection is carried out prior to or following a stroke of the full stroke injection. Thus, the check of whether an error is present in the opening behavior may be implemented as an on-board diagnosis. The ballistic partial injection or the on-board diagnosis may be carried out prior to every stroke of the full stroke injection, for example, or in certain time intervals and/or after certain covered distances of the internal combustion engine. This makes, in particular, the implementation of a permanent monitoring possible. Since the ballistic partial injection may be carried out in a quantity and torque neutral manner, the ballistic partial injection does not influence the full stroke injection and thus the regular operation of the internal combustion engine.

In one advantageous embodiment, a voltage signal is detected at the valve element and used to determine the reference value. Here, a voltage signal is, in particular, determined at an active element of the injector, i.e., at a solenoid coil or a piezoelectric actuator. The voltage signal is, in particular, determined in the course of controlling the injector (e.g., a controlled valve operation, CVO) in this case. A closing point in time of the injector may be determined with the aid of the voltage signal. The closing delay period may also be determined in a simple manner with the aid of this determined closing point in time. This closing delay period represents a typical reference closing delay period which is a function of the injector and is used as a reference value or as a reference closing delay period for the comparison with the ballistic closing delay period. If the ballistic closing delay period deviates from the reference value by more than a certain threshold value, this unambiguously indicates an error in the opening behavior.

In the case of a magnetic injector, for example, the movement of the magnet armature in the solenoid coil induces a voltage which may be determined as the above-mentioned voltage signal. The movement of the armature may thus be inferred from the voltage signal at the solenoid coil. In the case of a piezoelectric injector, a voltage, which may be determined as the above-mentioned voltage signal, may, for example, be induced in the piezoelectric actuator.

A diagnosis of the injector may be carried out if an error in the opening behavior is detected. It is checked in this case whether an error is in fact present in the opening behavior. In the course of this diagnosis, the injector is thoroughly examined and the opening behavior of the injector is precisely determined. A diagnosis of this type is carried out, in particular, outside of the regular operation of the internal combustion engine. For this purpose, the internal combustion engine is, in particular, operated in a special mode. In the course of this special mode, a basic adaption of the internal combustion engine is carried out, in particular. Here, test runs and learning injections are carried out, in particular, and the internal combustion engine is operated according to certain fuel pressure specifications. In this way, the result of the method according to the present invention may be initially verified prior to replacing the injector. Thus, the result of the method according to the present invention is cross-checked one more time, thus preventing a non-defective injector from being erroneously replaced.

The opening delay period of the injector may be determined. In particular, the determination of this opening delay period may be carried out in the course of the above-described check of whether an error is present in the opening behavior. If this determined opening delay period deviates from a stored (e.g., in a control or a control unit) reference value of the opening delay period, this means that an error is in fact present in the opening behavior of the injector. In order to determine the opening delay period, more complex processes requiring more effort may be carried out in a repair shop, for example. The opening delay period is carried out, in particular, with the aid of the method discussed in DE 10 2009 028 650 A1.

The ballistic partial injection may be carried out in a quantity and torque neutral manner. In this way, the ballistic partial injection does not influence or exacerbate the smooth running, the fuel consumption, the exhaust gas values or the performance output of the internal combustion engine. In particular, when the ballistic partial injection is carried out prior to a stroke in the course of the full stroke injection, the ballistic partial injection still does not influence the internal combustion engine.

An arithmetic unit according to the present invention, e.g., a control unit of a motor vehicle, is configured to carry out a method according to the present invention, in particular from a programming point of view.

It is also advantageous to implement the method in the form of software, since this is particularly cost-effective, in particular when an executing control unit is used for other tasks and is thus present anyway. Suitable data carriers for providing the computer program are, in particular, floppy disks, hard drives, flash memories, EEPROMs, CD-ROMs, DVDs, and many others. It is also possible to download a program via computer networks (Internet, Intranet, etc.).

Further advantages and embodiments of the present invention result from the description and the appended drawing.

It is understood that the above-mentioned features and the features to be elucidated below are usable not only in the given combination, but also in other combinations or alone without departing from the scope of the present invention.

The present invention is schematically illustrated in the drawing on the basis of exemplary embodiments and described in greater detail in the following with reference to the drawing.

### BRIEF DESCRIPTION OF THE DRAWINGS

FIG. 1 schematically shows a block diagram of an internal combustion engine which is configured to carry out one specific embodiment of a method according to the present invention.

FIG. 2 schematically shows a magnetic injector which is suitable to carry out one specific embodiment of a method according to the present invention.

FIG. 3 schematically shows a diagram of the opening and closing behavior of an error-free magnetic injector in a full stroke injection.

FIG. 4 schematically shows a diagram of the opening and closing behavior of a defective magnetic injector in a full stroke injection.

FIG. 5 schematically shows a diagram of the opening and closing behavior of an error-free and a defective magnetic injector in a ballistic partial injection.

### DETAILED DESCRIPTION

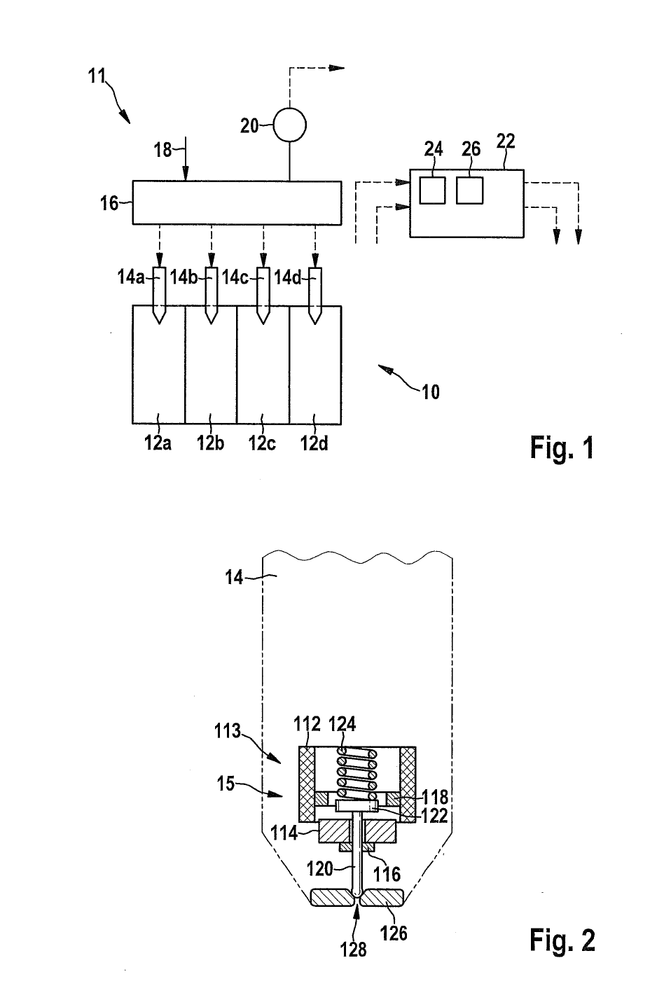

FIG. 1 shows a simplified diagram of a fuel system 11 of an internal combustion engine 10 having, in the present case, four cylinders 12 and associated, electrically actuated injectors (or injection valves) 14 for injecting fuel which are provided with indices a through d correspondingly to the cylinders of internal combustion engine 10, but are denoted in the following without indices in the event of general reference. In this specific example, injectors 14 are configured as electromagnetically actuated magnetic injectors. Injectors 14 may, however, also be configured as piezoelectric injectors, for example. Magnetic injectors 14 each have an electromagnetically actuated valve element 15 (cf. FIG. 2) which is not visible in FIG. 1. A common-rail block 16 which is supplied with fuel by a high-pressure line 18 and monitored by a pressure sensor 20 is illustrated upstream from magnetic injectors 14. Internal combustion engine 10 is configured either as a gasoline engine or as a diesel engine. In the right upper part of FIG. 1, a control unit 22 together with indicated outgoing and incoming control lines is illustrated as well as an electrical memory medium 24 contained therein and a computer program 26. Control unit 22 is in this case configured to carry out one specific embodiment of a method according to the present invention.

During operation, a fuel pump (not illustrated) supplies common-rail block 16 via high-pressure line 18, pressure sensor 20 communicating the instantaneous pressure to control and/or regulating unit 22 via an indicated signal line. Four magnetic injectors 14 inject a certain fuel quantity into cylinders 12 as a function of an activation signal.

FIG. 2 schematically shows some elements of a magnetic injector 14 for the direct fuel injection of an internal combustion engine 10. In FIG. 2, magnetic injector 14 is illustrated in a closed state. An electromagnet 113 is illustrated including an armature winding (or a solenoid coil) 112 and an armature 114 which is pulled into armature winding 112 when energized. The movement of armature 114 is delimited by a resting position 116 as well as an armature stop 118. In the case of closed magnetic injector 14 or in the case of a non-actuated final position, armature 114 rests on resting position 116. A valve needle (or an injector needle) 120, which is fixedly connected at its upper end in the drawing to a disc-shaped plate 122, is guided through an axial bore in armature 114. A coil spring 124 acts on plate 122 and thus applies a force to valve needle 120 in the closing direction. Valve needle 120, plate 122, and, optionally, armature 114 together form valve element 15.

At the lower end of magnetic injector 14 in the drawing, a valve seat 126 is situated. An outlet opening 128 is closed in the case of a valve needle 120 resting on valve seat 126, and opened in the case of a lifted valve needle 120 (not illustrated). Other elements of magnetic injector 14, such as the fuel channels, are not illustrated. All movements occur in a vertical direction with relation to FIG. 2.

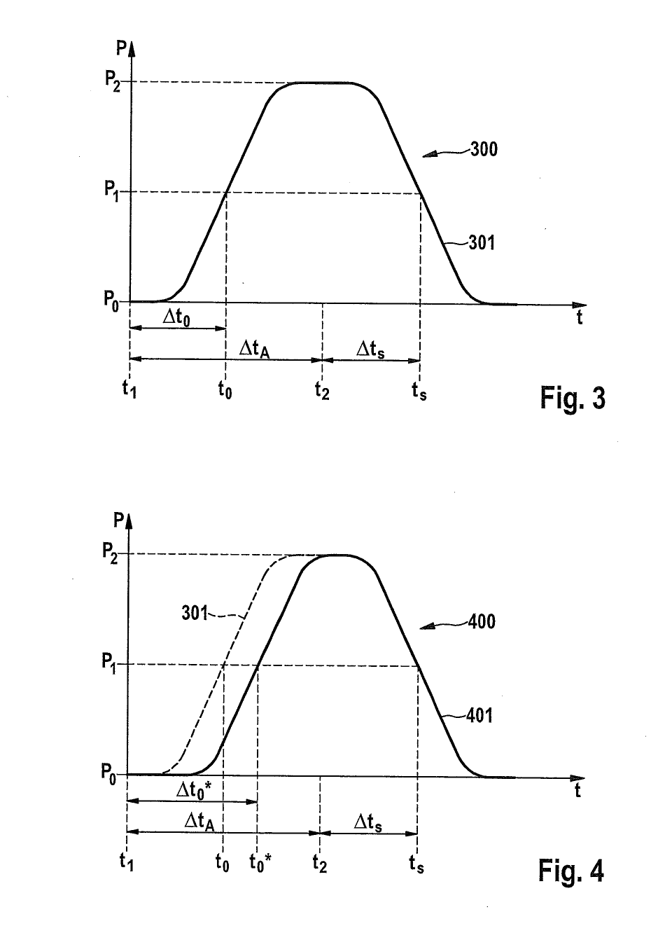

In FIG. 3, a diagram 300 is illustrated which shows the movement of armature 114 in the case of electromagnetic activation of valve element 15 in a full stroke injection. Curve 301 symbolizes in this case a position P of armature 114 over time t. Curve 301 describes in this case an error-free magnetic injector which does not have an error in the opening behavior.

At point in time t₁, the activation of valve element 15 starts and armature winding 112 is supplied with current. At point in time t₂, the activation of valve element 15 ends and armature winding 112 is no longer supplied with current. The time period between beginning t₁ and end t₂ of the activation is referred to as an activation period Δt_{A}.

After the beginning of activation t₁, an opening delay period Δt_{O} elapses before armature 114 moves from its resting position 116 in the direction of armature stop 118, valve needle 120 unblocks outlet opening 128, and thus opens valve element 15 at point in time t_{O}. The position of armature 114 in resting position 116 is identified by reference symbol P₀ in diagram 300. The position of armature 114 in which valve element 15 opens is identified by reference symbol P₁. The position of armature 114 at armature stop 118 is identified by reference symbol P₂.

Analogously, a closing delay period Δtₛ elapses after the end of activation t₂ before armature 114 reaches position P₁ in which valve element 15 recloses at point in time tₛ.

A diagram 400 which is analog to diagram 300 is illustrated in FIG. 4. Curve 401 describes the movement of armature 114 in the case of electromagnetic activation of valve element 15 in the full stroke injection of a defective magnetic injector which has an error in the opening behavior. Curve 301 of an error-free magnetic injector is illustrated as a dashed line in diagram 400 for comparison purposes.

Activation time Δt_{A} in the example of FIG. 4 is the same as the one in the example of FIG. 3. The opening behavior of the error-free magnetic injector according to curve 301 is, in this case, significantly different from the opening behavior of the defective magnetic injector according to curve 401. The defective magnetic injector or its valve element opens in this case only at a point in time t_{O}*, which takes place later than point in time t_{O}, at which the error-free magnetic injector or its valve element opens. Accordingly, opening delay period Δt_{O}* of the defective magnetic injector is also greater than opening delay period Δt_{O} of the error-free magnetic injector.

Since, however, the error in the opening behavior does not affect the closing behavior, closing delay periods Δt_{S} of the defective and the error-free magnetic injectors are identical according to curves 301 and 401.

For this reason, control unit 22 carries out one specific embodiment of a method according to the present invention. Here, a ballistic partial injection is carried out during the ongoing regular operation of internal combustion engine 10. This ballistic partial injection advantageously precedes or succeeds the full stroke injection in this case. Furthermore, the partial injection is carried out in a quantity and torque neutral manner so that the internal combustion engine continues running unchanged.

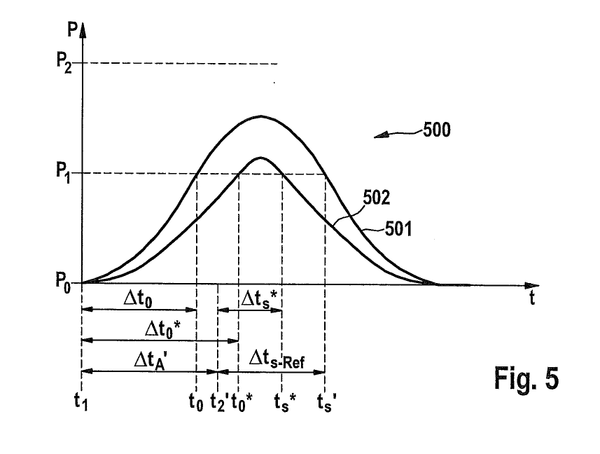

In FIG. 5, a diagram 500 is illustrated which shows the movement of armature 114 in the case of electromagnetic activation of valve element 15 in the ballistic partial injection. Curve 501 describes here an error-free magnetic injector, and curve 502 describes a defective magnetic injector.

In the ballistic partial injection, the activation already ends at point in time t₂′. Activation period Δt_{A}′ is thus shorter in the ballistic partial injection than activation period Δt_{A} in the full stroke injection. Armature 114 thus cannot move up to armature stop 118 but moves back into its resting position 116 before valve element 15 fully opens. The opening behavior thus directly transitions into the closing behavior or the movement of armature 114 for opening valve element 15 directly transitions into the movement of armature 114 for closing valve element 15. The opening and the closing behavior are thus coupled to one another.

In the ballistic partial injection according to curves 501 and 502, opening delay periods Δt_{O} and Δt_{O}* of the error-free and the defective magnetic injectors are analog to the opening delay periods according to curves 301 and 401 in the full stroke injection. In the ballistic partial injection, the ballistic closing delay periods of the error-free and the defective magnetic injectors are, however, also significantly different.

The error-free magnetic injector or its valve element closes at point in time t_{S}′ according to curve 501. This ballistic closing delay period Δt_{S-Ref} of the error-free magnetic injector according to curve 501 in the ballistic partial injection therefore represents a reference closing delay period and is determined as a reference value for the closing delay period of the magnetic injector. In order to determine this reference value Δt_{S-Ref}, a voltage signal of armature winding 112 of the magnetic injector may be detected and evaluated.

The defective magnetic injector or its valve element according to curve 502 closes at an earlier point in time t_{S}*. Ballistic closing delay period Δt_{S}* of the defective magnetic injector according to curve 502 is a lot shorter than ballistic closing delay period Δt_{S-Ref} of the error-free magnetic injector according to curve 501.

Thus, ballistic closing delay period Δt_{S}* is shorter than the reference value. It is thus detected that the magnetic injector according to curve 502 has an error in the opening behavior.

What is claimed is:

1. A method for detecting an error in an opening behavior of an injector of an internal combustion engine, the injector having an electrically actuated valve element, the method comprising:
performing a ballistic partial injection, wherein the injector is ballistically activated, the valve element not being opened up to a lift stop;
determining a ballistic closing delay period;
comparing the determined ballistic closing delay period with a reference value; and
detecting an error in the opening behavior of the injector based on the comparing.

2. The method of claim 1, wherein the ballistic partial injection precedes or succeeds a full stroke injection.

3. The method of claim 1, wherein a voltage signal is detected at the valve element and used to determine a closing delay period of the injector as a reference value.

4. A method of claim 1, wherein a diagnosis of the injector is carried out when an error in the opening behavior of the injector is detected, it being checked whether an error is present in the opening behavior of the injector.

5. The method of claim 4, wherein an opening delay period of the injector is determined for checking whether an error is present in the opening behavior of the injector.

6. The method of claim 1, wherein the ballistic partial injection is carried out in a quantity and torque neutral manner.

7. The method of claim 1, wherein an error is detected in the opening behavior of a magnetic injector or a piezoelectric injector.

8. A control unit, comprising:
a control arrangement to detect an error in an opening behavior of an injector of an internal combustion engine, the injector having an electrically actuated valve element, by performing the following:
performing a ballistic partial injection, wherein the injector is ballistically activated, the valve element not being opened up to a lift stop;
determining a ballistic closing delay period;
comparing the determined ballistic closing delay period with a reference value; and
detecting an error in the opening behavior of the injector based on the comparing.

9. A computer readable medium having a computer program, which is executable by a processor, comprising:
a program code arrangement having program code for detecting an error in an opening behavior of an injector of an internal combustion engine, the injector having an electrically actuated valve element, by performing the following:
performing a ballistic partial injection, wherein the injector is ballistically activated, the valve element not being opened up to a lift stop;
determining a ballistic closing delay period;
comparing the determined ballistic closing delay period with a reference value; and
detecting an error in the opening behavior of the injector based on the comparing.

10. The computer-readable medium of claim 9, wherein the ballistic partial injection precedes or succeeds a full stroke injection.
